(19) United States
(12) Patent Application Publication
(10) Pub. No.: US 2022/0015547 A1
(43) Pub. Date: Jan. 20, 2022

(54) PILLOW WITH COMPOSITE MATERIAL SUPPORTING STRUCTURE

(71) Applicant: SHUN-TIEN HUNG, Taichung City (TW)

(72) Inventor: SHUN-TIEN HUNG, Taichung City (TW)

(21) Appl. No.: 16/932,982

(22) Filed: Jul. 20, 2020

(51) Int. Cl. A47C 7/38; H04W 4/80; A47G 9/10

(52) U.S. Cl. CPC A47C 7/383; A47G 9/1045; H04W 4/80

(57) ABSTRACT

A pillow has a supporting structure and a cushion. The supporting structure is made of composite materials and is pre-stressed and resiliently bended. The cushion is resilient and covers the supporting structure. With the supporting structure and the cushion, the pillow provides two-stage resilient support. When a user rests his head on the pillow, the cushion is compressed easily at first, and then the supporting structure being resiliently bended provides sufficient support to the cervical spine of the user, making the cervical spine of the user rest in natural relaxation when the user rests on the pillow.

### BACKGROUND OF THE INVENTION

### 1. Field of the Invention

The present invention relates to a pillow, and more particularly to a pillow having a supporting structure made of a composite material.

### 2. Description of Related Art

People spend one-third of their lives on sleeping. Pillows play an important role as people sleep. In fact, the main function of the pillows is not just to support a user's head. A more important function of the pillows is to provide support for the cervical spine of the user. The pillow lets the cervical spine of the user rest in a naturally relaxed condition when the user lies on the bed. Therefore, the supporting strength and resiliency of the pillows are very important.

The supporting strength and the resiliency of the pillows depend on the materials of the pillows. Common materials include feathers, cotton, artificial fibers, and even wood. Although the pillows made of feathers, cotton, or man-made fibers are resilient, the pillows cannot provide proper support for the cervical spine of the user. The cervical spine of the user may be compressed due to lack of proper support. On the contrary, the pillows made of wood provide strong support but lack resiliency. The pillow made of wood cannot be compressed with the weight of the user's head and let the cervical spine of the user relaxed in a stretched condition.

Accordingly, the pillows made of a single material such as feathers, cotton, rayon, or wood cannot provide appropriate support for the cervical spine of the user and is unable to keep the cervical spine of the user in a relaxed condition when the user lies on the bed.

To overcome the shortcomings of the pillows made of a single material, the present invention provides a pillow with composite materials supporting structure to mitigate or obviate the aforementioned problems.

### SUMMARY OF THE INVENTION

The main objective of the present invention is to provide a pillow that provides proper support to the cervical spine of the user.

The pillow has a supporting structure and a cushion. The supporting structure is made of composite materials and is prestressed and resiliently bended. The cushion is resilient and covers the supporting structure. With the supporting structure and the cushion, the pillow in accordance with the present invention is able to provide two-stage resilient support. When a user rests his head on the pillow in accordance with the present invention, the cushion is compressed easily at first, and then the supporting structure being resiliently bended provides sufficient support to the cervical spine of the user. Therefore, the pillow can offer appropriate support to the cervical spine of the user and let the cervical spine of the user rest in natural relaxation when the user rests on the pillow.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a pillow in accordance with the present invention;

FIG. 2 is a partially cross-sectional perspective view of the pillow in FIG. 1;

FIG. 3 is a cross-sectional side view of a supporting structure of the pillow in FIG. 1;

FIG. 4 is another perspective view of the pillow in FIG. 1;

FIG. 5 is an optional perspective view of the pillow in FIG. 1, showing the pillow and a wireless headphone working together;

FIG. 6 is a perspective view of a second embodiment of a pillow in accordance with the present invention;

FIG. 7 is a partially cross-sectional perspective view of the pillow in FIG. 6;

FIG. 8 is a perspective view of a third embodiment of a pillow in accordance with the present invention; and

FIG. 9 is a partially cross-sectional perspective view of the pillow in FIG. 8.

### DETAILED DESCRIPTION OF PREFERRED EMBODIMENTS

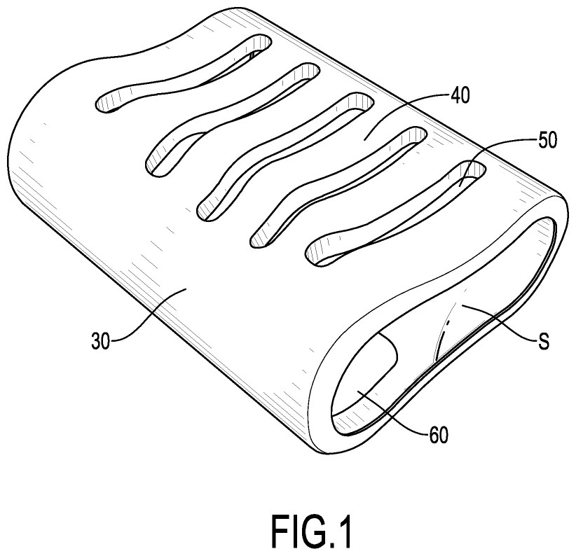

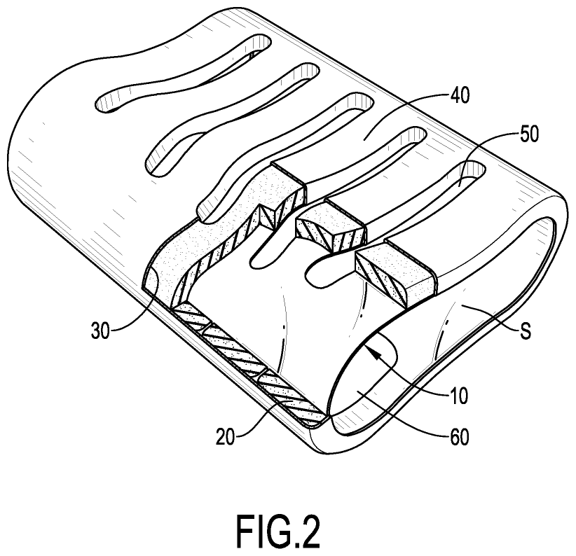

With reference to FIGS. 1 and 2, a first embodiment of a pillow with composite material supporting structure in accordance with the present invention is elongated and has an elongating direction, a supporting structure 10, a cushion 20, a pillow case 30, a headrest portion 40, multiple vents 50, and an audio player 60.

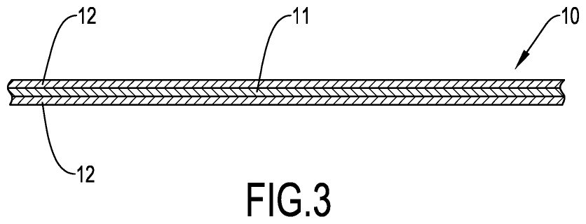

With reference to FIGS. 1 and 2, the supporting structure 10 is made of composite materials. The supporting structure 10 is resiliently bended and extends along the elongating direction. The supporting structure 10 is pre-stressed and is able to restore to its original configuration after being pressed by load. With reference to FIGS. 1 and 2, the supporting structure 10 of the first embodiment has a cross-section being annular and a receiving space S is enclosed by the supporting structure 10. Cell phones, portable chargers, or the audio player 60 can be stored in the receiving space S. With reference to FIGS. 2 and 3, the supporting structure 10 has a carbon fiber composite layer 11 and two glass fiber composite layers 12. The carbon fiber composite layer 11 is clamped between the two glass fiber composite layers 12. Since glass fibers have better tenacity than carbon fibers, the supporting structure 10 with the carbon fiber composite layer clamped by the two glass fiber composite layers has good ductility to sustain loads and is less breakable. Moreover, when carbon fibers of the carbon fiber composite layer 11 are broken, the two glass fiber composite layers 12 wrap the carbon fiber composite layer 11 that is broken to avoid exposure of the broken carbon fibers. Practically, the supporting structure 10 may be implemented as a carbon fiber composite layer 11 covered by a glass fiber composite layer 12 or even be implemented as a carbon fiber composite layer 11. In the present invention, matrixes of the carbon fiber composite layer 11 and each glass fiber composite layer 12 are thermoplastic resin. The carbon fiber composite layer 11 and each glass fiber composite layer 12 are respectively reinforced by carbon fibers and glass fibers.

With reference to FIGS. 1 and 2, the cushion 20 is wrapped around and covers the supporting structure 10. The cushion 20 may be made of foam, rubber, emulsion, or similar flexible materials. The pillow case 30 is sleeved on the cushion 20.

With reference to FIGS. 1 and 2, the headrest portion 40 is recessed in a top of the pillow. The headrest portion 40 is designed according to a user's head contour for receiving and well supporting the user's head.

With reference to FIGS. 1 and 2, the multiple vents 50 are defined through the headrest portion 40 and communicate with the receiving space S for providing the user's head with good ventilation and convection. In the first embodiment of the present invention, each one of the multiple vents 50 is elongated and extends across the elongating direction of the pillow. Specifically, each vent 50 extends laterally.

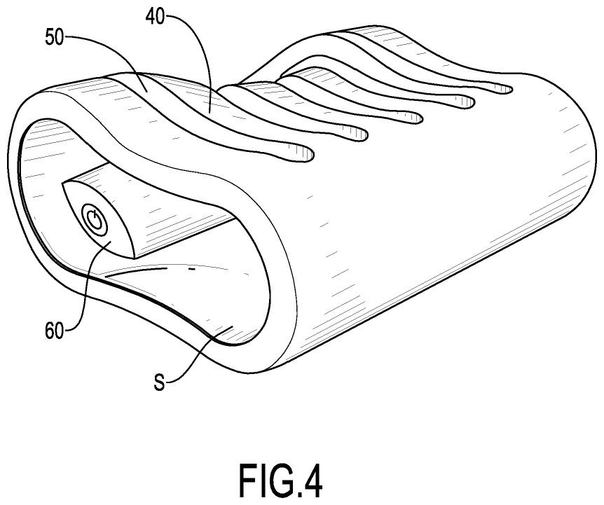

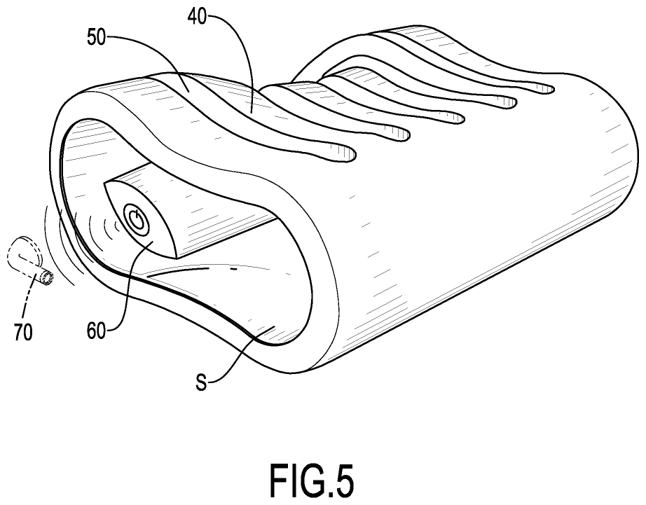

With reference to FIGS. 2 and 4, the audio player 60 is disposed in the receiving space S. The audio player 60 can play relaxing music, sounds of birds, woods, or flowing water before falling sleep. The audio player 60 may even play pleasant sounds that can trigger autonomous sensory meridian response (ASMR). The audio player 60 may also play sounds in the morning for wake-up alarm. When the user's head rests on the headrest portion 40, the supporting structure 10 is disposed between the audio player 60 in the receiving space S. The supporting structure 10 isolates the audio player 60 and the user's head even when the cushion 20 and the supporting structure 10 are pressed by the user's head. The supporting structure 10 prevents the user's head from abutting against a hard casing of the audio player 60 to avoid discomfort. With reference to FIGS. 4 and 5, the audio player 60 may further comprise a radio-frequency identification (RFID) module. The RFID module may be connected to a wireless headphone via short-range wireless communication protocols to expand applications of the present invention.

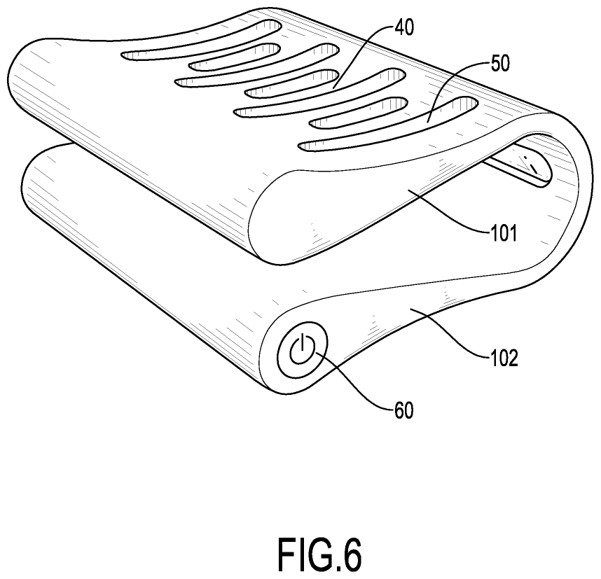

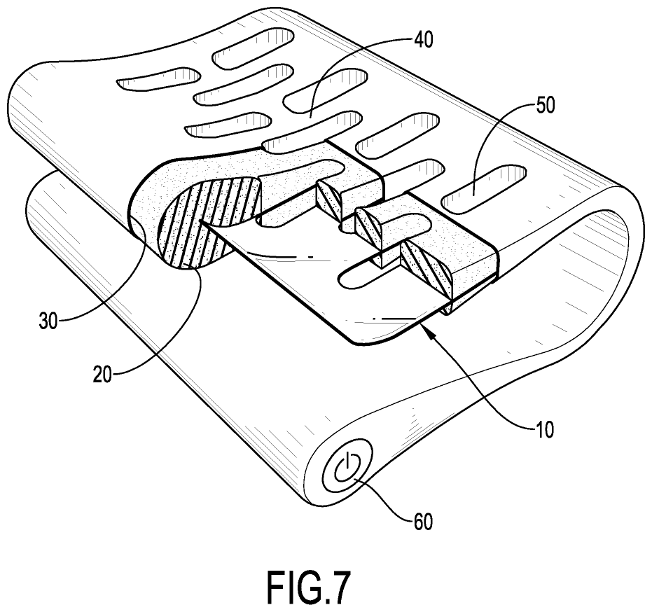

A second embodiment of the pillow in accordance with the present invention is shown in FIGS. 6 and 7. FIGS. 6 and 7 respectively show two different configurations of the second embodiment. The second embodiment is similar to the first embodiment. The second embodiment also has the supporting structure 10, the cushion 20 wrapped around and covering the supporting structure 10, the pillow case 30 sleeved on the cushion 20, the headrest portion 40 recessed in the top of the pillow, the multiple vents 50 defined through the headrest portion 40, and the audio player 60 that can make sounds. In the second embodiment, the supporting structure 10 is made of composite materials, pre-stressed and resiliently bended as well.

With reference to FIGS. 6 and 7, in the second embodiment, the pillow in accordance with the present invention is also U-shaped in cross-section. The pillow in the second embodiment also has a first arm 101, a second arm 102, and an opening disposed at a lateral side of the pillow. The first arm 101 and the second arm 102 extend along a same direction. The headrest portion 40 is recessed in the first arm 101. The audio player 60 is mounted inside the second arm 102. In the second embodiment of the present invention, the headrest portion 40 and the audio player 60 are respectively disposed at the first arm 101 and the second arm 102. Therefore, the second embodiment can prevent the user's head from abutting against the audio player 60 and feeling uncomfortable.

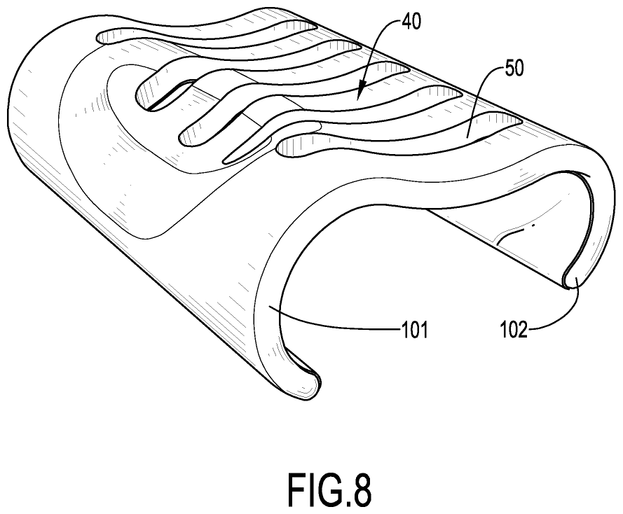

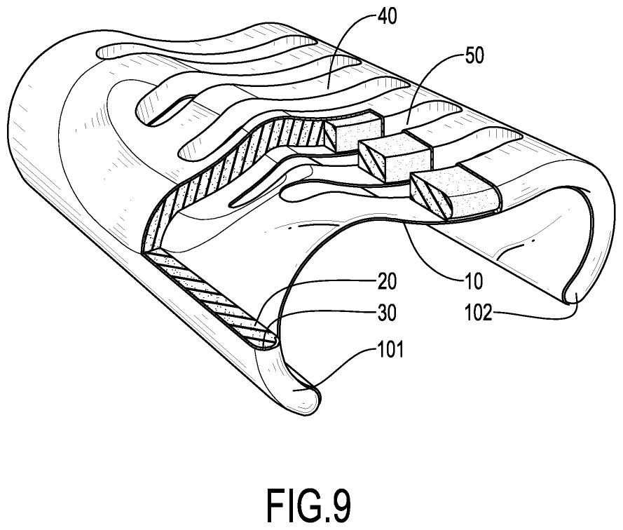

With reference to FIGS. 8 and 9, the third embodiment is similar to the second embodiment. The third embodiment also has the supporting structure 10, the cushion 20, the pillow case 30, the headrest portion 40, and the multiple vents 50. In the third embodiment, the pillow is also U-shaped in cross-section, and has the first arm 101, the second arm 102, and the opening. In the third embodiment, the first arm 101 and the second arm 102 extend downward together, and the opening is disposed at a bottom of the pillow.

The supporting structure 10 and the cushion 20 of the pillow in accordance with the present invention have different elastic modulus. Therefore, the pillow is able to provide two-stage resilient support. The cushion 20 is compressed easily when the pillow is subjected to the weight of the user's head. Then, the supporting structure 10 being resiliently bended provides sufficient support to the cervical spine of the user. The pillow in accordance with the present invention offers appropriate support to the cervical spine of the user. The cervical spine of the user can rest in natural relaxation when the user rests on the pillow.

In the first and second embodiments of the present invention, even if the cushion 20 and the supporting structure 10 are compressed when being subjected to the weight of the user's head, the supporting structure 10 isolates the user's head and the audio player 60, prevents the user's head from abutting against the audio player 60, and keeps the user comfortable.

Furthermore, in the present invention, the carbon fiber composite layer 11 is clamped between the two glass fiber composite layers 12. When the carbon fibers of the carbon fiber composite layer 11 is broken, the two glass fiber composite layers 12 with better tenacity can avoid exposure of the broken fibers.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pillow comprising:
a supporting structure made of composite materials and being pre-stressed and resiliently bended; and
a cushion being resilient and covering the supporting structure.

2. The pillow as claimed in claim 1, wherein the pillow has a headrest portion recessed in a top of the pillow.

3. The pillow as claimed in claim 2, wherein a receiving space is enclosed by the supporting structure.

4. The pillow as claimed in claim 3, wherein the pillow has multiple vents defined through the headrest portion and communicating with the receiving space.

5. The pillow as claimed in claim 4, wherein the pillow has an audio player disposed in the receiving space.

6. The pillow as claimed in claim 1, wherein
the pillow is U-shaped in cross-section and has
a first arm and a second arm extending to a same direction; and
an opening disposed at a lateral side of the pillow.

7. The pillow as claimed in claim 6, wherein
the pillow has
a headrest portion recessed in the first arm; and
an audio player mounted inside the second arm.

8. The pillow as claimed in claim 7, wherein the pillow has multiple vents defined through the headrest portion.

9. The pillow as claimed in claim 1, wherein
the pillow is U-shaped in cross-section and has
a first arm and a second arm extending downward; and
an opening disposed at a bottom of the pillow.

10. The pillow as claimed in claim 1, wherein the supporting structure has two glass fiber composite layers and a carbon fiber composite layer disposed between the two glass fiber composite layers.

11. The pillow as claimed in claim 2, wherein the supporting structure has two glass fiber composite layers and a carbon fiber composite layer disposed between the two glass fiber composite layers.

12. The pillow as claimed in claim 3, wherein the supporting structure has two glass fiber composite layers and a carbon fiber composite layer disposed between the two glass fiber composite layers.

13. The pillow as claimed in claim 4, wherein the supporting structure has two glass fiber composite layers and a carbon fiber composite layer disposed between the two glass fiber composite layers.

14. The pillow as claimed in claim 5, wherein the supporting structure has two glass fiber composite layers and a carbon fiber composite layer disposed between the two glass fiber composite layers.

15. The pillow as claimed in claim 6, wherein the supporting structure has two glass fiber composite layers and a carbon fiber composite layer disposed between the two glass fiber composite layers.

16. The pillow as claimed in claim 7, wherein the supporting structure has two glass fiber composite layers and a carbon fiber composite layer disposed between the two glass fiber composite layers.

17. The pillow as claimed in claim 8, wherein the supporting structure has two glass fiber composite layers and a carbon fiber composite layer disposed between the two glass fiber composite layers.

18. The pillow as claimed in claim 9, wherein the supporting structure has two glass fiber composite layers and a carbon fiber composite layer disposed between the two glass fiber composite layers.

19. The pillow as claimed in claim 18, wherein
the pillow has
a headrest portion recessed in a top of the pillow; and
multiple vents defined through the headrest portion.

20. The pillow as claimed in claim 1, wherein
the pillow has
a headrest portion recessed in a top of the pillow; and
multiple vents defined through the headrest portion.
